(19) United States
(12) Patent Application Publication
(10) Pub. No.: US 2018/0268052 A1
(43) Pub. Date: Sep. 20, 2018

(54) ANALYSIS OF INFORMATION IN A COMBINATION OF A STRUCTURED DATABASE AND AN UNSTRUCTURED DATABASE

(71) Applicant: HEWLETT PACKARD ENTERPRISE DEVELOPMENT LP, Houson, TX (US)

(72) Inventors: Haim Litvak, Yehud (IL); Dan Noter, Yehud (IL); Shiran Gabay, Yehud (IL); Yariv Snapir, Yehud (IL)

(21) Appl. No.: 15/556,089

(22) PCT Filed: Mar. 20, 2015
(86) PCT No.: PCT/US2015/021764

§ 371 Date: Sep. 6, 2017

(51) Int. Cl. G06F 17/30; G06Q 30/02

(52) U.S. Cl. CPC G06F 17/30684; G06Q 30/0282; G06F 17/30699

(57) ABSTRACT

A combination of a structured database and an unstructured database may be used to access input by a plurality of end users to data fields in interaction with an information system, where storage of the input is separated between the combination of the structured database and the unstructured database, to analyze multiple choice and numerical input in the structured database, to analyze textual input in the unstructured database, and determine a first set of textual inputs that each includes a related textual topic in the textual input.

### BACKGROUND

Collection of information via end user surveys is a practice to gather end user perspectives on various aspects of product or service interaction. An example of such survey may be a satisfaction survey sent to an end user after resolution of an issue that prompted a support request to a support (e.g., service) provider.

User satisfaction surveys may be intended to provide results to help continually improve products and related services. However, an amount and variety of information (e.g., data) resulting from such surveys may be difficult to analyze with available techniques, especially when there is free textual commentary provided by the end users in response to the survey.

### BRIEF DESCRIPTION OF THE DRAWINGS

FIG. 1 illustrates a diagram of an example of an information system for analysis of information in a combination of a structured database and an unstructured database according to the present disclosure.

FIG. 2 illustrates a diagram of an example of a visual representation of a user interface for analysis of information in a combination of a structured database and an unstructured database according to the present disclosure.

FIG. 3 illustrates a diagram of an example of a combination of a structured database and an unstructured database according to the present disclosure.

FIG. 4 illustrates a diagram of an example of a system for analysis of information in a combination of a structured database and an unstructured database according to the present disclosure.

FIG. 5 illustrates a diagram of an example computing device for analysis of information in a combination of a structured database and an unstructured database according to the present disclosure.

FIG. 6 illustrates a flow diagram of an example method for analysis of information in a combination of a structured database and an unstructured database according to the present disclosure.

### DETAILED DESCRIPTION

Survey formats and purposes may vary. For example, a satisfaction survey may be sent to an end user (e.g., a user of an information technology (IT) product, such as a computer, and/or of a programmed application, such as software) after a support request by the end user concerning a technical issue (e.g., difficulty with performing a hardware and/or software controlled operation). A survey may be intended to measure level of satisfaction of end users with a new service or a new product. In some examples, a survey may be used to measure a risk of a change planned to an IT service or product perceived by project managers and/or survey analysts. The change to the IT service or product may have been suggested by end users in response to the satisfaction surveys.

A survey may include various types of questions that prompt various types of responses. Some questions may have response options that are structured for selection from a number of multiple choices, such as a radio button list, rating values (e.g., 1 to 5), or Booleans (e.g., yes or no), or that are structured for entry of numerical values, such as dates, numbers, etc. In addition, some surveys may ask questions to which an answer is intended to be provided as an unstructured written comment, such as in free text. Survey analysts may separate or limit the aggregated structured response data, for example, into more distinct components to look at subsets that the analysts can scroll through to find specific textual answers. For example, in a help desk satisfaction survey, one may first separate the responses concerning a given service or helpdesk group based on end users that indicated low satisfaction ratings in the structured responses and then scroll through a set of textual answers and/or comments to determine specific feedback from the most dissatisfied users.

The preceding approach may have limitations. In surveys that accumulate a large number of responses (e.g., by lasting a long period of time and/or that cover a large number of products and/or services provided by an organization) the set of textual answers and/or comments may still be too large to read through even after the separation. Moreover, in some situations, end users who indicate high satisfaction would be removed from consideration by the described separation even though their textual answers and/or comments may still include valuable insights or suggestions.

The present disclosure describes a number of systems and processes to enable extraction of trends, causes of end user dissatisfaction, valuable insights or suggestions, and/or opinions on these held by project managers and/or survey analysts, among others, to increase a likelihood of overcoming the just-described limitations. Examples of the present disclosure include methods, machine-readable media (MRM), and systems for analysis of information in a combination of a structured database and an unstructured database. Using storage of the answers (e.g., data fields) in survey responses separated (e.g., split) between a combination of a structured database and an unstructured database may enable, for example, extraction of textual concepts repeated by end users in answers to free text questions across large sets of answers. In some examples, this extraction may be accomplished using a textual clustering application, as described herein. This may enable a survey analyst to find (e.g., define) valuable insights or suggestions that otherwise might remain undiscovered in the collection of survey answers.

For convenience, the present disclosure may present such concepts in the context of IT support requests to an IT support provider (e.g., a help desk, service group, etc.), although the concepts are not so limited. That is, results from any type of survey, questionnaire, poll, etc., may be subject to the analysis described herein.

An example method may include accessing data fields in survey responses associated with end user satisfaction with support request interactions, where storage of the data fields is separated between a combination of a structured database and an unstructured database. The method may include analyzing content of either multiple choice, numerical, and/or contextual data fields in the survey responses that are stored in the structured database using an application associated with the structured database and analyzing textual data fields that are stored in the unstructured database to define a related (e.g., the same) textual topic in the textual data fields from a plurality of survey responses to form a set by using a textual clustering application associated with the unstructured database. The method may include filtering (e.g., parsing or limiting to a smaller subset) the defined related textual topic set with at least one data value extracted via analysis of either the multiple choice, the numerical, and/or the contextual data fields.

An issue connected with the end user satisfaction may be determined by the filtering of the defined related textual topic set with the at least one extracted data value. In various examples, determining the issue may include discovering a cause of the issue, identification of a group of end users particularly affected by the issue, valuable insights and suggestions for dealing with the issue, etc. Accordingly, the approach described herein may reduce time and effort involved in discovery, location, and/or definition of related textual topics repeated across large sets of data, which may thus enable consideration of valuable input that might have been otherwise overlooked.

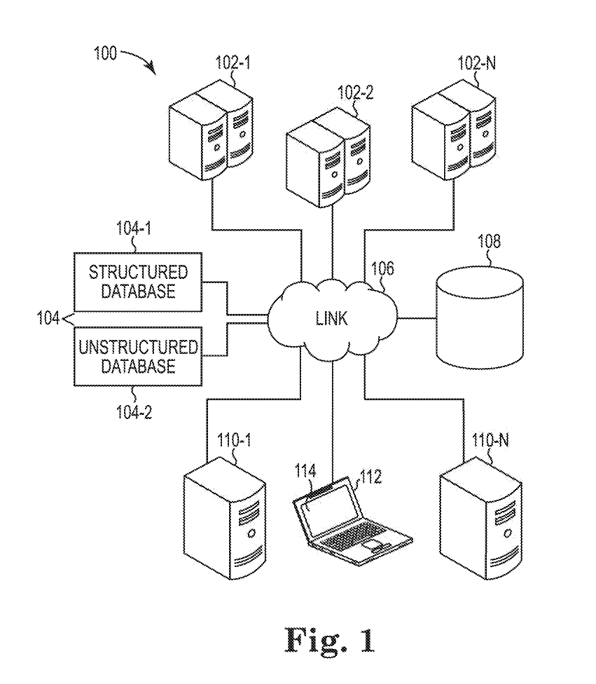

FIG. 1 illustrates a diagram of an example of an information system for analysis of information in a combination of a structured database and an unstructured database according to the present disclosure. The information system 100 may include a combination 104 of a structured database 104-1 and an unstructured database 104-2, as described further herein, a data store 108, server devices 102-1, 102-2, . . . , 102-N, and/or user devices 110-1, . . . , 110-N. In some examples, the server devices may be used for distribution to and/or receipt of surveys from users (e.g., end users, project managers, survey analysts, etc.), although examples are not so limited. In various examples, the structured database 104-1 and the unstructured database 104-2 may be separate databases (e.g., separated at different nodes of a network) or the structured database 104-1 and the unstructured database 104-2 may be portions of the same database that store structured and unstructured data, respectively. The user devices 110-1, . . . , 110-N may include a user device 112 that includes a user interface 114. In some examples, the user device 112 may be used in responding to surveys through the user interface 114, although response to surveys is not so limited. In some examples, the user devices 110-1, . . . , 110-N, and 112 may include the hardware and/or instructions (e.g., software) that prompted the support request.

In some examples, the server devices 102-1, 102-2, . . . , 102-N may include computing devices through which response may be made or coordinated to support requests received from the user devices 110-1, 110-N, 112. The user devices 110-1, 110-N, 112 may include browsers and/or other applications to communicate support requests and/or survey responses via a communication link 106 (e.g., network, local area network (LAN), internet, etc.) to the server devices 102-1, 102-2, . . . , 102-N. In various examples, interaction with a support provider (e.g., at a help desk) may be communicated through various avenues, such as a website, a chat line, e-mail, a telephone, etc., through which the support request may also be communicated.

In various examples, input from the user devices 110-1, 110-N, 112 may be directed via the link 106 and/or the server devices 102-1, 102-2, . . . , 102-N for storage in the server devices, the structured database 104-1 or the unstructured database 104-2, and/or another data store 108, depending on the content of the input. For example, as described herein, structured response content in structured response data fields of surveys may be directed for storage in the structured database 104-1, whereas unstructured response content in unstructured response data fields may be directed for storage in the unstructured database 104-2.

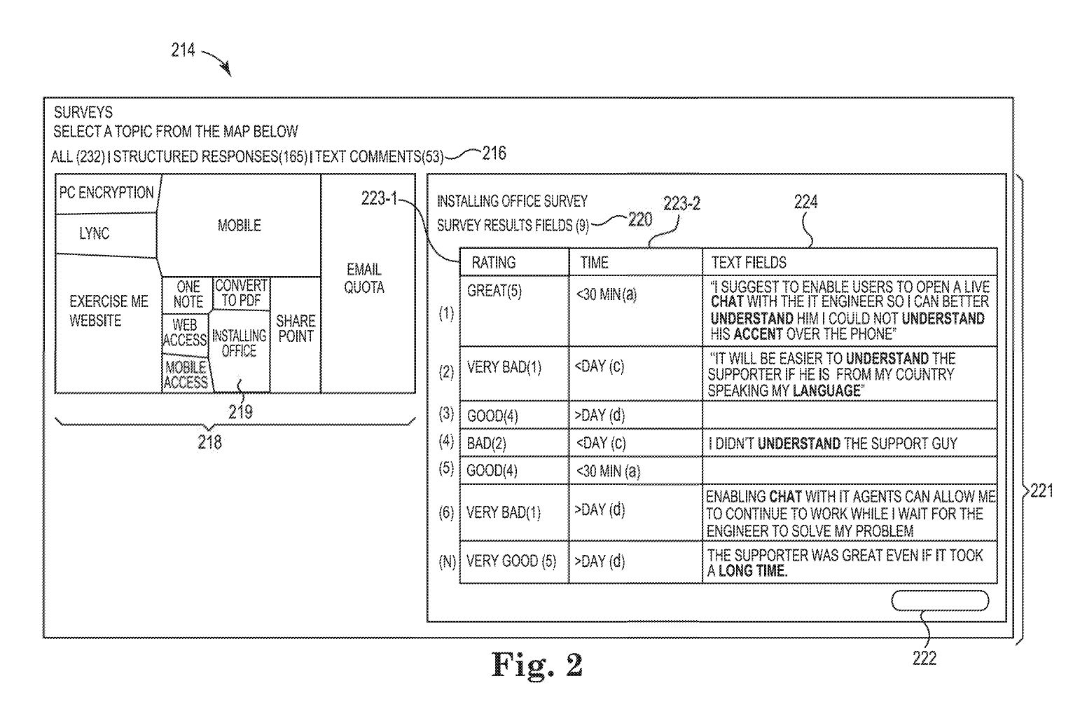

FIG. 2 illustrates a diagram of an example of a visual representation of a user interface for analysis of information in a combination of a structured database and an unstructured database according to the present disclosure. The user interface 214 illustrated in FIG. 2 displays content suitable for completion of surveys by end users, program managers, survey analysts, etc., and/or for viewing survey results by the program managers, survey analysts, etc. The user interface 214 may include a number of tabs 216 that may be utilized to categorize end user interactions with a survey information system. For example, the number of tabs 216 may include “ALL” end user interactions, which may be quantified as 232 interactions, “STRUCTURED RESPONSES” of end user interactions, which may be quantified as 165 interactions, “TEXT COMMENTS” of end user interactions, which may be quantified as 53 interactions, among various other possible categories for end user interactions.

Each of the number of tabs 216 may include a particular category of end user interactions. For example, the tab labeled “STRUCTURED RESPONSES” may include of user responses to questions having multiple choice and numerical value choices or contextual data (e.g., contextual data such as the identity of a support provider handling the support request, locations of an end user seeking the support, time and date of the support provided, etc.). In contrast, the tab labeled “TEXT COMMENTS” may include user responses to questions each having a data field for entry of free text responses.

The information in tabs 216 may be more suitable for display to the program managers, survey analysts, etc., rather than to the end users. In some examples, program managers, survey analysts, etc., interacting with the user interface 214 may utilize the number of tabs 216 to filter the number of end user interactions and display a particular category of the number of end user interactions as stored in the appropriate structured database 104-1 for the structured responses entered in structured data fields and the unstructured database 104-2 for the text comments entered in textual data fields.

The user interface 214 may include a topic map 218. The topic map 218 may, for example, include a number of topics relating to hardware and software products provided by (e.g., manufactured, distributed, and/or marketed by the organization) an organization and/or support provided by the organization (e.g., via help desks) for the hardware and software products. For example, the number of topics may include “INSTALLING OFFICE” 219 relating to installation of word processing software. Each of the number of topics within the topic map 218 may be selected to display information relating to the selected topic and/or the selected tab from the number of tabs 216. For example, the tab “STRUCTURED RESPONSES” may be selected from the number of tabs 216 and the topic “INSTALLING OFFICE” 219 may be selected from the topic map 218. In some examples, end users may select a certain topic on a user interface in order to answer survey questions related to that topic, although examples of this disclosure are not limited to responding to surveys in this manner. In this example, results of a survey corresponding to the topic of receiving support for installing Office are displayed in a results section 221. Such a survey may be completed by a number of end users and the results of the survey (e.g., based on the surveys completed by end users) may be viewed by a program manager or survey analyst. The number of such completed surveys may be displayed at the “SURVEY RESULTS FIELDS” 220.

The results section 221 illustrated in FIG. 2 shows results of a short survey to determine end user satisfaction after having interacted with a support provider in response to a support request concerning installing Office software, which may or may not have resulted in resolution of the issue prompting the support request. For clarity, the survey shown in the results section 221 has the following three questions, although actual surveys may have many more questions of varying types. Question 1 may be, “How satisfied were you with the service you received?”, with presented multiple choice response ratings ranging from 1 to 5. Question 2 may be, “How long did it take to resolve the issue?”, with multiple choice response times presented as: a) less than 30 minutes; b) less than 3 hours; c) less than a day; d) more than a day; and e) not resolved. Question 3 may be, “Please input in your own words: what would you suggest to improve the help desk experience?”, with a data field for entry of an free text response.

The survey results for multiple choice and/or numerical structured responses may be displayed separately from free textual unstructured responses. For example, responses to structured Question 1 may be displayed in a “RATING” column 223-1 and responses to structured Question 2 may be displayed in a “TIME” column 223-2, whereas responses to unstructured Question 3 may be displayed in a “TEXT FIELDS” column 224. As shown in the results section 221, end users may respond to some questions and not to other questions. For example, among survey responses from end users 1, 2, . . . , N, all end users provided answers for the structural rating 223-1 and time 223-2 columns, whereas end users 3 and 5 did not provide a textual response in the text field 224.

A help desk support service, for example, may handle a thousand support requests per day and a number of end users that are asked as a result to respond to a satisfaction survey may be 300 per day. At a 50% response rate, 150 survey responses may be received each day. This may result in a survey analyst accumulating more than 700 survey responses to analyze each week.

The survey analyst might begin by analyzing the responses having the worst ratings for the support provided, such as a rating of (1) for “very bad” for end users 2 and 6 in the results section 221 in FIG. 2. When there are 30-100 of such survey responses, that may be around the number that the survey analyst may be able to analyze in a given time period. However, the example responses in the results section 221 show that end user 1 suggests that a “live chat” would improve the support interaction by making the exchange with the support provider easier to “understand” despite his “accent”, even though end user 1 rated the support interaction as (5) for “great”. The suggestion for a “chat” and comments on difficulty with being able to “understand” the support provider also are included in survey responses from end users 2 and 6, in addition to end user 4, who gave a rating of (2) for “bad”, with end user 2 suggesting that the support provider should speak the end user's “language”.

However, eliminating survey responses from consideration that have good “ratings” may reduce a likelihood of learning that even end users who have had a good interaction in response to the support request still suggest using a “live chat”, potentially for reasons other than those provided by end users having had a bad interaction. As such, a frequency of suggestions for enabling “chat”, and a range of reasons for suggesting such an enablement, may be a repeated topic that might be overlooked by eliminating from consideration survey responses that have a high rating of the support interaction.

In actual survey situations, the number of questions as well as the number of additional data fields for entry of responses may be much larger. Taking into account a variety of selection criteria for analysis by various service desk personnel for different products or support services at a number of different locations, the likelihood may be increased for repeated textual topics being overlooked.

Accordingly, the present discourse describes a number of systems and processes to enable extraction of trends, causes of end user dissatisfaction, valuable insights or suggestions, and/or opinions on these held by project managers and/or survey analysts, among others, based upon reduced time and effort involved in discovery, location, and/or definition of related textual topics repeated across large sets of data. Accordingly, the present disclosure describes using a combination of two separate databases for collecting and storing survey response answers.

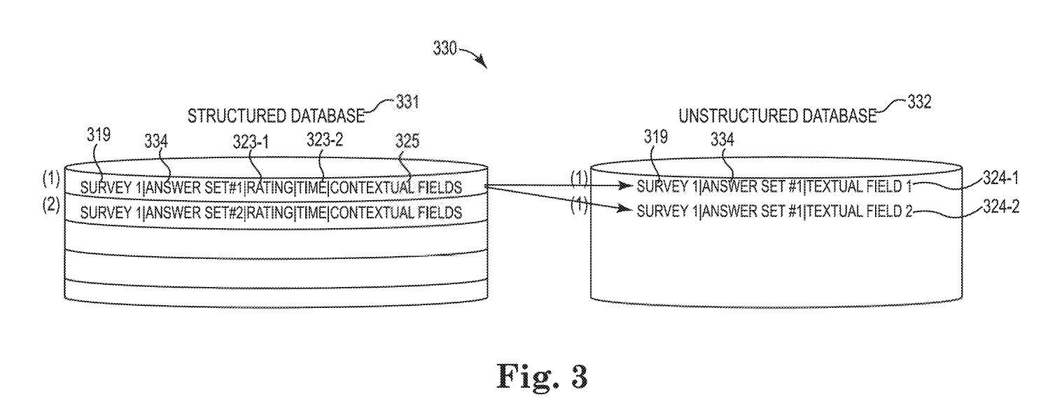

FIG. 3 illustrates a diagram of an example of a combination of a structured database and an unstructured database according to the present disclosure. A system 330 as described in the present disclosure may have a combination of a first database, which may be termed a structured database 331 or an analytic database, and second database, which may be termed an unstructured database 332 or a text search database.

The structured database 331 may be a database designed for analytical analysis of high volumes of structured data with integrated statistical applications to enable at least some of the analytical analyses. Such a database may, for example, have a column-oriented storage organization to increase performance of sequential record analysis in order to handle fast-growing volumes of data while providing fast query response when used in query-intensive applications for data warehouses.

The unstructured database 332 may be a database designed for high volume textual data that enables text search and automated textual topic clustering in real time through an integrated textual topic clustering application. Such a database may, for example, enable conceptual and contextual understanding of content from unstructured data, such as from free text content in e-mail, web pages, social media, transaction logs, etc., through meaning-based computing that enables discerning relationships between data.

As used herein, an application refers to instructions executed by a processing resource that direct the processing resource to perform a number of tasks. In various examples, at least some of the tasks may be performed using a programmable logic device (PLD), application specific integrated circuit (ASIC), or the like.

When an end user answers a survey 319, individual survey answer sets 334 from structured data fields (e.g., rating 323-1, time 323-2, etc.) for each survey 319 may be collected along with “contextual data” that is in contextual fields 325 and that is related to the entity or entities being analyzed may be stored in the structured database 331. For example, contextual data related to the support requests being dealt with in FIG. 2 may be collected (e.g., identification of the help desk that handled the request and/or the location of the end user that requested the service, among other such contextual information). Structured answers (e.g., rating values, numerical values) and additional contextual data may be stored in the structured database so as to enable creation of structured report analytics (e.g., an average satisfaction rating grouped per help desk or an average support request resolution time based on location of the end user making the support request, among other such combinations of structured and contextual data).

Free text answers, in contrast, from each textual field 324-1, 324-2, . . . , 324-N (e.g., from a plurality of textual fields) may be stored in the unstructured database 332, along with additional data fields to enable filtering of the free text data (e.g., with a rating value 323-1 and/or a time value 323-2 from structured data fields in the survey response). For example, answer set #1 334 of survey 319 with structured responses stored in the structured database 331 may have two textual answers stored separately in textual field 1 324-1 and textual field 2 324-2 in the unstructured database 332.

In addition, an identifier of each individual survey 319 (e.g., to enable proper organization thereof and/or access thereto through the topic map 218 in FIG. 2) and an identifier for individual survey answer sets 334 in each survey 319 (e.g., to enable proper organization thereof and/or access thereto through the tabs 216 in FIG. 2) may be provided in both databases in order to match an answer (e.g., a line) in the analytical structured database to the same answer (e.g., line) in the unstructured textual database.

Using a system for analysis of information in the combination of the structured database and the unstructured database may, for example, allow a survey analyst to initiate analysis by obtaining a summary overview of textual answers provided in the survey without delving into structurally oriented survey responses and breaking them down into subsets to determine content of textual data fields. That is, in the unstructured database 332, the textual data fields 324-1, 324-2, . . . , 324-N are readily accessible and analyzable.

The summary presentation may utilize an automated textual clustering application that identifies related topics that appear repeatedly in the textual fields 324-1, 324-2, . . . , 324-N in the unstructured database 332. In the example textual fields 224 of FIG. 2, that may be the terms “chat” or “understand” for end users 1, 2, 4, and 6. From this overview, the survey analyst may drill deeper into such topics, which may be “hot topics” of particular interest to the organization, and which may involve parsing a topic result set (data) using additional keyword search terms or phrases. This approach filters the topic set to provide a subset (e.g., a smaller set) of textual fields (e.g., answers) that additionally contains at least one of these keywords or phrases. For example, when the first set of related topics includes the word “understand”, “accent” (e.g., as included in the text for end user 1) or “language” (e.g., as included in the text for end user 2) may be used as keywords to determine whether they are repeatedly used within the results.

In some examples, a survey analyst may initiate analysis by obtaining an overview of the textual answers provided in the survey in a similar manner to that just described. However, the storage capability of the combination of the structured and unstructured databases enables further parsing of the data according to a particular date or time period (e.g., the most recent week, month, etc., based upon the contextual data in the contextual fields 325) or according to a specific question corresponding to specific textual field 324-1, 324-2 when there is more than one free text question in the survey.

The survey analyst also may parse the data according to a level chosen in response to a multiple choice rating question 223-1 (e.g., “How satisfied were you with the service you received?” from 1 to 5) or a time question 223-2 (e.g., “How long did it take to resolve the issue?” with selectable times or allowance for numerical entries). This may, for example, enable ascertaining whether a particular repeated topic is characterized by appearing in badly rated support interactions, whether the topic is of interest to a broader set of end users, and/or whether a particular repeated topic is characterized by appearing in a specific time period, among many other possibilities. The structured response values may be accessed by the unstructured database 332 from the structured database 331 for parsing the answers in the textual fields 324-1, 324-2, . . . , 324-N or the structured response values may be imported from the structured database 331 to the unstructured database 332 (e.g., to be saved in the answer sets 334) for efficiently parsing the answers in the textual fields 324-1, 324-2, . . . , 324-N.

In some examples, a survey analyst may initiate analysis by obtaining reports derived from the structured data fields stored in the structured data base 331. For example, the survey analyst may begin with reports such as an “average satisfaction rating grouped per help desk” or an “average support request resolution time based on location of the end user”. Such reports may enable the survey analyst to start identifying “trendy areas” where low satisfaction for end users is common. The disclosure presented herein may enable the survey analyst to more readily discern the cause or causes for the low satisfaction, or high satisfaction for the same or another matter, by obtaining a report and/or by viewing a user interface that displays clustered textual topics that repeat for a grouping having a particular satisfaction level or range (e.g., ratings from 1-2) for their support interactions.

The survey and/or the results section 221, in addition to the topics 218, shown in FIG. 2 may include a number of topics, questions, and/or issues relating to the end user interactions based on trend data (e.g., trends of a quantity of the same and/or similar end user interaction). The trend data may be generated by analyzing trends of the end user interactions. For example, end user interactions for a number of questions relating to a particular topic may be tracked, and a quantity of each of the number of questions relating to the particular topic may be determined. In addition, the results section 221 may display a number of questions within a particular quantity range (e.g., questions with a greater quantity compared to another type of question, etc.) and/or in a particular order (e.g., questions with a greatest quantity to questions with a least quantity, etc.).

Analyzing trends of the number of end user interactions may include analyzing trends of a number of determined end user technical issues (e.g., personal computer (PC) encryption issues, installing Office issues, convert to PDF issues, etc.). That is, the results section 221 may be organized based on trend analysis of the number of end user interactions and/or end user technical issues. For example, the results section 221 may, for example, have a tab (e.g., as shown schematically at 222 in FIG. 2) to request production of a report (e.g., a list) of end user interactions and/or end user technical issues that have a particular quantity or a particular textual topic, among other possibilities. In this example, the particular quantity may be a quantity of end user interactions and/or determined end user technical issues that occur over a particular time period (e.g., day, week, month, etc.). Depending on whether an issue relates to being determined through analytical analysis of the structured database 331 or analysis of free textual unstructured responses of the structured database 332, the report may be produced via access to the appropriate database.

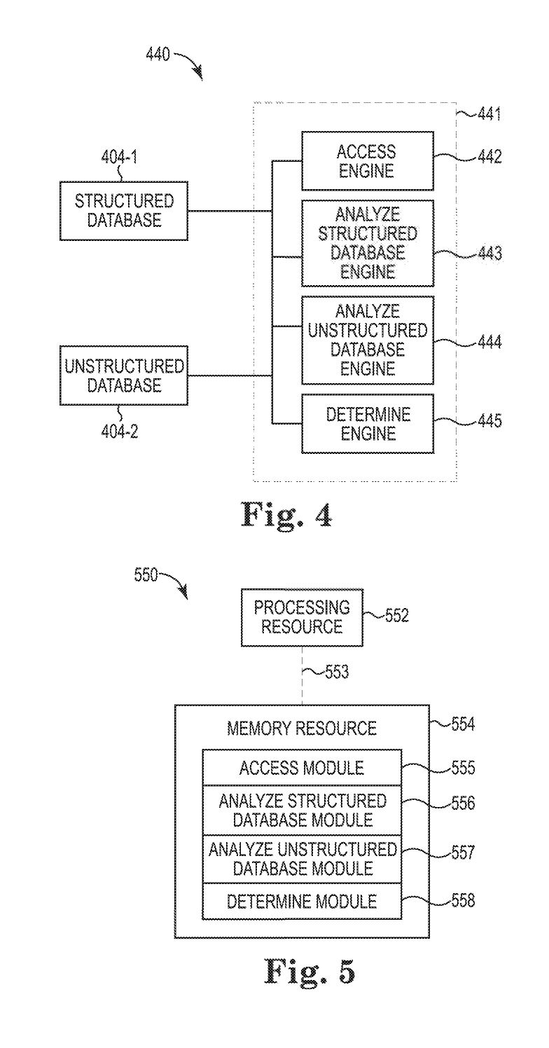

FIG. 4 illustrates a diagram of an example of a system for analysis of information in a combination of a structured database and an unstructured database according to the present disclosure. The system 440 may include a combination of a structured database 404-1 and an unstructured database 404-2 (e.g., as described in connection with FIGS. 1 and 3, etc.), and a number of engines 441 to enable execution of particular tasks 442, 443, 444, 445. The system 440 may be in communication with the structured database 404-1 and the unstructured database 404-2 via a communication link, and may include the number of engines (e.g., access engine 442, analyze structured database engine 443, analyze unstructured database engine 444, determine engine 445, etc.). The system 440 may include additional or fewer engines than illustrated to perform the various tasks described herein. The system 440 may represent programmed instructions and/or hardware.

The number of engines may include a combination of hardware and instructions (e.g., programming) to perform a number of tasks described herein (e.g., analyze information in the combination of the structured database and the unstructured database, etc.). The instructions may be executable by a processing resource and stored in a non-transitory memory resource (e.g., computer-readable medium (CRM), MRM, etc.), or may be hard-wired in hardware (e.g., logic).

The access engine 442 may include hardware and/or a combination of hardware and instructions (e.g., programming) to access data fields in survey responses associated with interactions with end users, where storage of the data fields is separated between the combination of the structured database 404-1 and the unstructured database 404-2. The survey responses may be intended to discern end user satisfaction with a support request interaction in an attempt to resolve technical difficulties (e.g., software and/or hardware of an end user device not operating as desired, software and/or hardware of an end user device not operating to specification of a manufacturer, etc.). In this example, the end user may create a support request (e.g., service order, description of problem, etc.) to describe the technical difficulty to a support provider (e.g., information system manager, hardware and/or software repair specialist, etc.). In various examples, the survey responses may be provided by a plurality of the end users and/or a plurality of project managers and/or survey analysts in reaction to content of end user textual data fields (e.g., to determine feasibility of implementation of suggestions provided by the end users in the survey responses).

The analyze structured database engine 443 may include hardware and/or a combination of hardware and instructions (e.g., programming) to analyze (e.g., statistically analyze) content of multiple choice and numerical data fields that may be stored in the structured database 404-1. For example, averages, medians, and/or norm values or ranges of structured responses, such as satisfaction ratings, times for support resolution, etc., along with standard deviations, probabilities, confidence intervals, etc., may be calculated during the analysis to assist in the overall analysis of the survey results.

The analyze unstructured database engine 444 may include hardware and/or a combination of hardware and instructions (e.g., programming) to analyze content of free textual data fields that may be stored in the unstructured database 404-2. As described herein, the analysis may define (e.g., find) a related textual topic (e.g., that may have been entered by end users using the same or similar terms that are determined to have a same or similar meaning) in the textual data fields from a plurality of survey responses. The related textual topic may be used to form a first set of textual data fields. In some examples, the instructions may be executable to determine by an automated text clustering application the first set of textual data fields that each includes the related textual topic by being implemented on the unstructured database.

In addition, the determine engine 445 may include hardware and/or a combination of hardware and instructions (e.g., programming) to determine from the content of a particular one of the multiple choice and the numerical data fields a similar entry in a plurality of the survey responses to filter the first set. For example, the instructions may be executable to determine the similar entry from the structured database as an automated task based upon a similar or same entry in a structured data field (e.g., rating, time, etc.). In some examples, the similar entry may be determined based upon comparison to an average value of the entry. For example, the comparison to the average value may be being at or above an upper threshold value or at or below a lower threshold in comparison to the average rating, time, etc., as determined from statistical analysis of the content of the multiple choice and the numerical data fields stored in the structured database.

In some examples, the instructions may be executable to filter (e.g., parse or limit) the first set of the related textual topic by the similar entry (e.g., a same value or range of values for rating, time, etc., or statistics related to the same) to determine a second set (e.g., a smaller subset). In some examples, the second set may further define the first set of the related textual topic to an issue in connection with end user satisfaction with the interactions. Further defining the related textual topic to the issue may include, for example, discovering a cause of the issue, identification of a group of end users particularly affected by the issue, finding valuable insights and/or suggestions for dealing with the issue, discerning opinions of project managers and/or survey analysts of the insights and/or suggestions made by the end users, etc. In some examples, the system may include a display engine having instructions executable to display a visual representation of the second set (e.g., on user interface 114 shown in FIG. 1 and/or on results section 221 shown in FIG. 2.

FIG. 5 illustrates a diagram of an example computing device for analysis of information in a combination of a structured database and an unstructured database according to the present disclosure. The computing device 550 may utilize programmed instructions, hardware, hardware with instructions, and/or logic to perform a number of tasks described herein.

The computing device 550 may be any combination of hardware and program instructions to share information. The hardware, for example, may include a processing resource 552 and/or a memory resource 554 (e.g., CRM, MRM, database, etc.) The processing resource 552, as used herein, may include any number of processors capable of executing instructions stored by the memory resource 554. The processing resource 552 may be integrated in a single device or distributed across multiple devices. The program instructions (e.g., computer-readable instructions (CRI), machine-readable instructions (MRI), etc.) may include instructions stored on the memory resource 554 and executable by the processing resource 552 to implement a desired task (e.g., analyze information in the combination of the structured database and the unstructured database, etc.).

The memory resource 554 may be in communication with the processing resource 552. The memory resource 554, as used herein, may include any number of memory components capable of storing instructions that may be executed by the processing resource 552. Such a memory resource 554 may be a non-transitory CRM or MRM. The memory resource 554 may be integrated in a single device or distributed across multiple devices. Further, the memory resource 554 may be fully or partially integrated in the same device as the processing resource 552 or it may be separate but accessible to that device and processing resource 552. Thus, the computing device 550 may be implemented on a participant device, on a server device, on a collection of server devices, and/or on a combination of the user device and the server device.

The memory resource 554 may be in communication with the processing resource 552 via a communication link (e.g., path) 553. The communication link 553 may be local or remote to a machine (e.g., a computing device) associated with the processing resource 552. Examples of a local communication link 553 may include an electronic bus internal to a machine (e.g., a computing device) where the memory resource 554 is one of volatile, non-volatile, fixed, and/or removable storage medium in communication with the processing resource 552 via the electronic bus.

A number of modules 555, 556, 557, 558 may include MRI that when executed by the processing resource 552 may perform a number of tasks. The number of modules 555, 556, 557, 558 may be sub-modules of other modules. For example, the determine module 558 and the analyze modules 556, 557 may be sub-modules and/or contained within the same computing device. In another example, the number of modules 555, 556, 557, 558 may comprise individual modules at separate and distinct locations (e.g., CRM, MRM, etc.).

Each of the number of modules 555, 556, 557, 558 may include instructions that when executed by the processing resource 552 may function as a corresponding engine, as described herein. For example, access module 555 may include instructions that when executed by the processing resource 552 may function as the access engine 442. In another example, the analyze modules 556 and 557 may include instructions that when executed by the processing resource 552 may function as the analyze engines 443 and 444.

The access module 555 may include MRI that when executed by the processing resource 552 may perform a number of tasks. For example, the access module 555 may access input by a plurality of end users to data fields (e.g., a plurality of data fields) in interaction with an information system 100 (e.g., as described in connection with FIG. 1). Storage of the input may be separated between a combination 104 of a structured database 104-1 and an unstructured database 104-2, as described in connection with FIGS. 1 and 3, and elsewhere herein. The analyze structured database module 556 may include MRI that when executed by the processing resource 552 may perform a number of tasks. For example, the analyze structured database module 556 may be used to analyze multiple choice input and/or numerical input that may be stored in the structured database. The analyze unstructured database module 557 may include MRI that when executed by the processing resource 552 may perform a number of tasks. For example, the analyze unstructured database module 557 may be used to analyze free textual input that may be stored in the unstructured database.

In addition, the determine module 558 may include MRI that when executed by the processing resource 552 may perform a number of tasks. For example, the determine module 558 may be used to determine a first set of textual inputs that each includes a related textual topic (e.g., based upon similar or the same terms being entered in free textual data fields) in the textual input. In some examples, the textual topic may be input by a program manager or survey analyst and/or may be determined by using an automated text clustering application integrated with the unstructured database.

The information system 100 may, in some examples, include survey results related to support requests by the end users (e.g., for support with IT issues). The related textual topic may be an issue related to end user satisfaction with a result of the support request.

The determine module 558, in some examples, may include MRI that when executed by the processing resource 552 may be used to filter (e.g., parse or limit) the first set of textual inputs, which may be determined from the unstructured database, by a keyword search to determine a second set, as described herein. For example, when the first set of related topics includes the word “understand”, “accent” (e.g., as included in the text for end user 1) or “language” (e.g., as included in the text for end user 2) may be used as keywords to determine whether they are repeatedly used within the results.

The determine module 558, in some examples, may include MRI that when executed by the processing resource 552 may be used to filter the first set of textual inputs by selection of either a multiple choice value and/or a numerical input value (e.g., as originally stored in or determined statistically from the structured database and/or as transferred for efficiency of access to the unstructured database). For example, the first set may be filtered based upon a response to a multiple choice rating question (e.g., “How satisfied were you with the service you received?” from 1 to 5) and/or a time question (e.g., “How long did it take to resolve the issue?” with selectable times or allowance for numerical entries).

The determine module 558, in some examples, may include MRI that when executed by the processing resource 552 may be used to filter the first set of textual inputs by selection of a particular contextual value from a plurality of contextual values. The plurality of contextual values may, for example, include dates for the input, a location of an end user providing the input, identification of a help desk (e.g., personnel and/or location) involved in interaction with the end user, etc. (e.g., as originally stored in the structured database and/or as transferred for efficiency of access to the unstructured database). For example, in a help desk satisfaction survey, one may filter the responses for a given service or help desk grouping with end users that indicated low satisfaction ratings in the structured responses or filter the responses from end users that indicated low satisfaction ratings with the given service or help desk grouping and then scroll through a set of textual answers and/or comments seeking specific feedback.

The determine module 558, in some examples, may include MRI that when executed by the processing resource 552 may be used to filter the first set of textual inputs by selection of a particular free textual data field from a plurality of free textual data fields in the input by the plurality of end users that may be stored in the unstructured database. For example, a survey may include a plurality of questions on different topics that prompt free text responses. Responses to the plurality of questions may be entered into a plurality of free textual data fields (e.g., as shown at 324-1, 324-2 in FIG. 3). Textual content from a particular contextual data field related to a particular topic may be selected for filtering the first set of inputs.

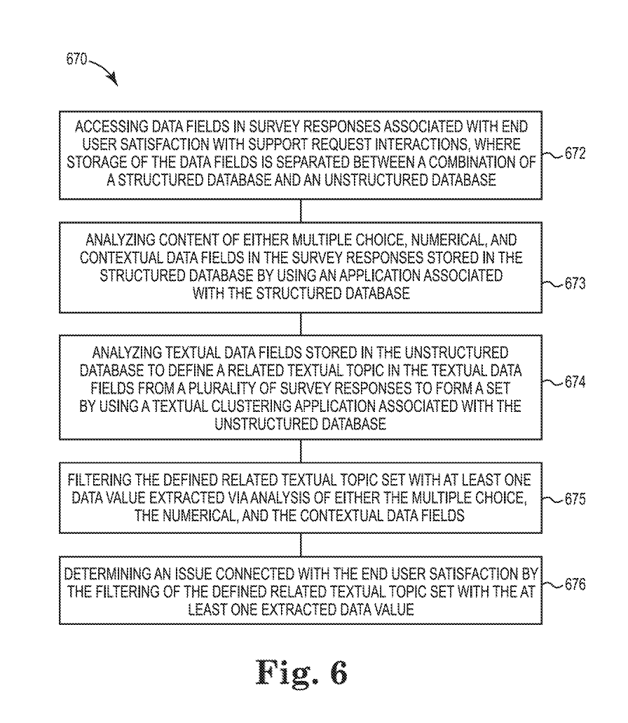

FIG. 6 illustrates a flow diagram of an example method for analysis of information in a combination of a structured database and an unstructured database according to the present disclosure. Unless explicitly stated, the method examples described herein are not constrained to a particular order or sequence. Additionally, some of the described method examples, or elements thereof, may be performed at the same, or substantially the same, point in time. As described herein, the actions, tasks, calculations, data manipulations and/or storage, etc., may be performed by execution of non-transitory machine-readable instructions stored in a number of memories (e.g., programmed instructions, hardware with instructions, hardware, and/or logic, etc.) of a number of applications. As such, a number of computing resources with a number of interfaces (e.g., user interfaces) may be utilized for implementing the tasks and/or methods described herein (e.g., via accessing a number of computing resources via the user interfaces).

The present disclosure describes a method 670 for accessing data fields in survey responses associated with end user satisfaction with support request interactions, where storage of the data fields is separated between a combination of a structured database and an unstructured database, as shown at 672 in FIG. 6. At 673, the method may include analyzing content of either multiple choice, numerical, and/or contextual data fields in the survey responses that are stored in the structured database using an application associated with the structured database. At 674, the method may include analyzing textual data fields that are stored in the unstructured database to define a related (e.g., the same) textual topic in the textual data fields from a plurality of survey responses to form a set by using a textual clustering application associated with the unstructured database. At 675, the method may include filtering (e.g., parsing or limiting to a smaller subset) the defined related textual topic set with at least one data value extracted via analysis of either the multiple choice, the numerical, and/or the contextual data fields. At 676, the method may include determining an issue connected with the end user satisfaction by the filtering of the defined related textual topic set with the at least one extracted data value.

In some examples, determining the issue may include filtering the set with a number of defined time periods extracted from the contextual data to determine a trend (e.g., an increase or decrease of frequency within and/or between time periods) of the end user satisfaction in connection with the defined related textual topic. Determining the issue may, in some examples, include filtering the set with either an identity of a support provider (e.g., identity of a help desk and/or personnel associated therewith), a location of the support provider, and/or a location of an end user, each of which may be extracted from the contextual data to determine a focus of the defined related textual topic. Determining the issue may, in some examples, include filtering the set with particular values or ranges of values extracted from either the multiple choice and/or the numerical data fields to determine a focus of the defined related textual topic.

The systems and processes described herein may facilitate a real time summary of textual answers to survey questions while reducing production of elaborate structured reports. For example, textual clustering may be done in real time to provide sets of textual answers related to any textual topic, thereby reducing time consuming and detailed search through subsets of interest in a structured data report. Implementing a textual clustering application in combination with a textual keyword search application may enable overview of repeated textual topics across all survey results without breaking the result set into subset. Focusing on textual topics, rather than on structured data analysis, may enable discovery of hidden topics of interest that repeat across answers both of satisfied and non-satisfied users. As such, the present disclosure may enable a proactive textual search within any set or subset of repeated topics in textual responses.

As used herein, “a” or “a number of” something may refer to one or more such things. For example, “a number of end users” may refer to one or more end users. Also, as used herein, “a plurality of” something may refer to more than one of such things.

As used herein, “logic” is a processing resource to execute the actions and/or tasks, etc., described herein, which includes hardware (e.g., various forms of transistor logic, application specific integrated circuits (ASICs), etc.), as opposed to computer executable instructions (e.g., programmed instructions, hardware with instructions, etc.) stored in memory and executable by a processor.

The figures herein follow a numbering convention in which the first digit corresponds to the drawing figure number and the remaining digits identify an element or component in the drawing. For example, 114 may reference element “14” in FIG. 1, and a similar element may be referenced as 214 in FIG. 2. Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

The specification examples provide a description of the applications and use of the system and method of the present disclosure. Since many examples may be made without departing from the spirit and scope of the system and method of the present disclosure, this specification sets forth some of the many possible example configurations and implementations.

What is claimed:

1. A non-transitory machine-readable medium storing instructions executable by a processing resource to cause a computing device to:
access input by a plurality of end users to data fields in interaction with an information system, wherein storage of the input is separated between a combination of a structured database and an unstructured database;
analyze multiple choice and numerical input in the structured database;
analyze textual input in the unstructured database; and
determine a first set of textual inputs that each includes a related textual topic in the textual input.

2. The medium of claim 1, wherein the information system includes:
survey results related to support requests by the end users; and
wherein the related textual topic is an issue related to end user satisfaction with a result of the support request.

3. The medium of claim 1, wherein the instructions are executable to filter the first set of textual inputs by a keyword search to determine a second set.

4. The medium of claim 1, wherein the instructions are executable to filter the first set of textual inputs by selection of either a multiple choice value or a numerical input value.

5. The medium of claim 1, wherein the instructions are executable to filter the first set of textual inputs by selection of a particular contextual value from a plurality of contextual values in the input by the plurality of end users.

6. The medium of claim 1, wherein the instructions are executable to filter the first set of textual inputs by selection of a particular free textual data field from a plurality of free textual data fields in the input by the plurality of end users.

7. A system for analysis of information in a combination of a structured database and an unstructured database, comprising:
a processing resource in communication with a non-transitory machine readable medium having instructions executable by the processing resource to:
access data fields in survey responses associated with interactions with end users, wherein storage of the data fields is separated between the combination of the structured database and the unstructured database;
analyze content of multiple choice and numerical data fields in the structured database;
analyze content of textual data fields in the unstructured database to define a related textual topic in the textual data fields from a plurality of survey responses to form a first set; and
determine from the content of a particular one of the multiple choice and the numerical data fields a similar entry in a plurality of the survey responses to filter the first set.

8. The system of claim 7, including instructions executable to filter the first set of the related textual topic by the similar entry to determine a second set;
wherein the second set further defines the first set of the related textual topic to an issue in connection with end user satisfaction with the interactions.

9. The system of claim 8, including a display engine to display a visual representation of the second set.

10. The system of claim 7, including instructions executable to determine the similar entry based upon comparison to an average value of the entry.

11. The system of claim 7, including instructions executable to determine by a text clustering application the first set of textual data fields that each includes the related textual topic.

12. A method for analysis of information in a combination of a structured database and an unstructured database, comprising:
accessing data fields in survey responses associated with end user satisfaction with support request interactions, wherein storage of the data fields is separated between the combination of the structured database and the unstructured database;
analyzing content of either multiple choice, numerical, or contextual data fields in the survey responses stored in the structured database by using an application associated with the structured database;
analyzing textual data fields stored in the unstructured database to define a related textual topic in the textual data fields from a plurality of survey responses to form a set by using a textual clustering application associated with the unstructured database;
filtering the defined related textual topic set with at least one data value extracted via analysis of either the multiple choice, the numerical, or the contextual data fields; and
determining an issue connected with the end user satisfaction by the filtering of the defined related textual topic set with the at least one extracted data value.

13. The method of claim 12, wherein determining the issue includes filtering the set with a number of defined time periods extracted from the contextual data to determine a trend of the end user satisfaction in connection with the defined related textual topic.

14. The method of claim 12, wherein determining the issue includes filtering the set with either an identity of a support provider, a location of the support provider, or a location of an end user extracted from the contextual data to determine a focus of the defined related textual topic.

15. The method of claim 12, wherein determining the issue includes filtering the set with particular values or ranges of values extracted from either the multiple choice or the numerical data fields to determine a focus of the defined related textual topic.
